(19) United States
(12) Patent Application Publication
(10) Pub. No.: US 2010/0153085 A1
(43) Pub. Date: Jun. 17, 2010

(54) Method, Apparatus and Computer Program Product for Providing Predictor Nodes for Context Models

(75) Inventor: Sailesh Kumar Sathish, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/634,039

(22) Filed: Dec. 9, 2009

Related U.S. Application Data
(60) Provisional application No. 61/122,022, filed on Dec. 12, 2008.

(51) Int. Cl. G06F 17/50

(52) U.S. Cl. 703/13

(57) ABSTRACT

An apparatus for providing predictive nodes for a context model may include a processor. The processor may be configured to receive a registration from a communication node having property values determinable via a context model in which the registration indicates a class of the communication node registering, record values for the communication node at defined time intervals, and enable the provision of predicted values based on the recorded values via a predictive formula determined based at least in part on the class.

### CROSS-REFERENCE

This application claims priority to U.S. Provisional Patent Application Ser. No. 60/122,022, filed on Dec. 12, 2008.

### TECHNOLOGICAL FIELD

Embodiments of the present invention relate generally to communication interface technology and, more particularly, relate to a method, apparatus, and computer program product for providing predictor nodes for context models.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In some situations, it may be desirable for an application (e.g., a web based application) to have the ability to access information or objects from a device providing information to the application. For example, context data including device data related to capabilities, current operating state and/or other device data that may be static and/or dynamic may be useful information for the application to access. In this regard, context data may be associated with content stored on a device in order to provide information which might assist in identifying data of interest. Context data is data that characterizes a particular situation at any point in time and may be either static or dynamic. Thus, for example, context data may represent device system and environment data. The context data may be used by applications for different purposes, such as generating metadata or performing an adaptation based on the context.

There are several context models available to provide context data. The context models available may have different architectures and various applications may be developed for use with specific ones of the different architectures. The applications may be able to change their behavior (e.g., via dynamic adaptations) based on changing context data. In general, the context models may be considered to be either data based models or object based models. In data based models, data is available without consideration of who provided the data. However, in object based models, each provider of data has an object representation and the object can be queried in order to get current updated data.

Delivery Context Client Interface (DCCI) is an object based context representation model through which applications can access device data such as delivery context information using, for example, a Document Object Model (DOM) like interface. As such, DCCI may act as a consumer interface for web applications (consumers) and providers of data to a tree-like interface. Providers of data can be any static or dynamic sources providing information such as device location, device orientation, screen brightness, battery strength, and many others.

One current limitation of object based models is that such models are only able to provide current data to a calling consumer application. As such, storage of past data, particularly for devices with limited resources such as mobile electronic devices, is typically not an option.

Accordingly, it may be desirable to provide a framework for overcoming at least some of the disadvantages discussed above.

### BRIEF SUMMARY

A method, apparatus and computer program product are therefore provided for providing predictor nodes for context models. In particular, a method, apparatus and computer program product are provided that create a mechanism for querying past data as well as getting predictions of future data. Thus, for example, more than just current data may be provided to a calling consumer application.

In one exemplary embodiment, a method of providing predictor nodes for context models is provided. The method may include receiving a registration from a communication node (e.g., a data provider node) having property values determinable via a context model in which the registration indicates a class of the communication node registering, recording values for the communication node at defined time intervals, and enabling the provision of predicted values based on the recorded values via a predictive formula determined based at least in part on the class.

In another exemplary embodiment, a computer program product for providing predictor nodes for context models is provided. The computer program product includes at least one computer-readable storage medium having computer-executable program code instructions stored therein. The computer-executable program code instructions may include program code instructions for receiving a registration from a communication node (e.g., a data provider node) having property values determinable via a context model in which the registration indicates a class of the communication node registering, recording values for the communication node at defined time intervals, and enabling the provision of predicted values based on the recorded values via a predictive formula determined based at least in part on the class.

In another exemplary embodiment, an apparatus for providing predictor nodes for context models is provided. The apparatus may include a processor configured to receive a registration from a communication node (e.g., a data provider node) having property values determinable via a context model in which the registration indicates a class of the communication node registering, record values for the communication node at defined time intervals, and enable the provision of predicted values based on the recorded values via a predictive formula determined based at least in part on the class.

In another exemplary embodiment, an apparatus for providing predictor nodes for context models is provided. The apparatus includes means for receiving a registration from a communication node (e.g., a data provider node) having property values determinable via a context model in which the registration indicates a class of the communication node registering, means for recording values for the communication node at defined time intervals, and means for enabling the provision of predicted values based on the recorded values via a predictive formula determined based at least in part on the class.

Embodiments of the invention may provide a method, apparatus and computer program product for employment in a web based, or other network based operating environment. As a result, for example, device users may enjoy improved capabilities with respect to applications and services accessible via the device.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a system showing an example of a communication environment according to an exemplary embodiment of the present invention;

FIG. 2 is a schematic block diagram of an apparatus for providing predictor nodes for context models according to an exemplary embodiment of the present invention;

FIG. 3 illustrates an exemplary framework for providing predictor nodes for context models according to an exemplary embodiment of the present invention; and

FIG. 4 is a block diagram according to an exemplary method for providing predictor nodes for context models according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Electronic devices have been rapidly developing in relation to their communication capabilities. As the capabilities of such devices have increased, applications that are sensitive to the capabilities of the devices (e.g., aware of the capabilities of the devices) have also been developed. Thus, for example, applications that are sensitive to the current operating state or context of devices have been developed. The devices are often able to determine, keep and communicate information about their own current operating state. For example, battery level, available bandwidth, certain device settings, hardware and software capabilities, local ambient light level and many other state related pieces of information may be determined and/or communicated to other devices. In order to communicate information on device operating state to various applications such as, for example, an application associated with accessing the web, an interface may be provided. An example of such an interface is Delivery Context Client Interface (DCCI), which is a World Wide Web Consortium (W3C) specification. DCCI may enable context information, which may be referred to as delivery context information, to be made available to scripts running in web pages within a browser on a device.

Context is generally defined as any information that can be used to characterize the situation or state of an entity. Context parameters may include parameters related to, for example, environmental context, social context, spatio-temporal context, task context, personal context, terminal context, service context, access context, and/or the like. Delivery context may be used to describe a set of characteristics of a device, a network, user preferences and other aspects that may apply to an interaction between the device and an application (e.g., a web application). Aspects of delivery context could be either static or dynamic. Static aspects may include color resolution, display size, keyboard arrangement or other fixed properties of the device. Dynamic aspects may include properties of the device that may change over time such as current battery level, device orientation, device location, other applications running, and numerous other characteristics.

DCCI is a mechanism through which applications can access delivery context information using a Document Object Model (DOM) like interface. Accordingly, applications can register event listeners on property nodes that initiate events based on property or other changes. In this regard, DCCI provides interfaces for applications that utilize delivery context information. DCCI provides a tree-like representation of context data on a device where context data can be represented in a hierarchical manner conforming to some standard ontology; e.g., the W3C Delivery Context Ontology (DCO).

Because of inherent relationships that context information may represent, context information may be represented as a tree structure. The tree structure may represent a hierarchical relationship between different context properties in which each property may form a node in the tree structure. DCCI is one example of such a tree structure, but it should be understood that embodiments of the present invention extend beyond this one example and may be extended to many other data structures that specify relationships between data objects and/or how they can be effectively distributed and shared.

Context may be determined, for example, based on a determination of various context parameters. DCCI uses context information to enable adaptation that permits interaction with various applications while considering device context. In some cases, when devices are brought in proximity to each other in certain networks, such as smart spaces, context information, e.g. information regarding device capabilities, may desirably be shared between such devices so that each device can receive some information about the capabilities of the other device. Some embodiments of the present invention may provide a mechanism by which nodes capable of maintaining states of previous interactions and also forming predictive and assistive services may be provided. Although embodiments will be described below in the context of a DCCI related environment, it should be understood that embodiments may also relate to other object based model environments.

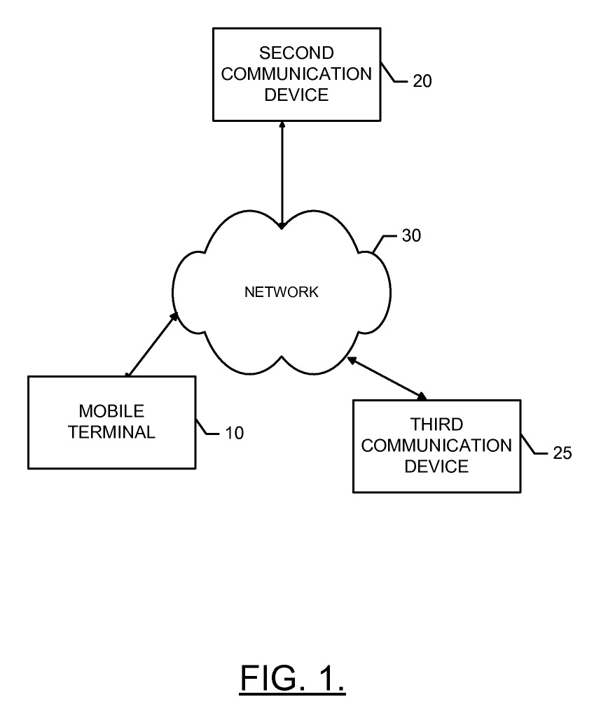

FIG. 1 illustrates a generic system diagram in which a device such as a mobile terminal 10 is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more additional communication devices, one of which is depicted in FIG. 1 as a third communication device 25. In some embodiments, not all systems that employ embodiments of the present invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. In some embodiments, the network 30 may be a P2P network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ a context model to assist in providing an interface between applications and providers. As such, for example, a consumer application may request information from a provider within the network 30 and any one of the devices of FIG. 1 (e.g., including the mobile terminal 10 or the second and third communication devices 20 and 25) may host a consumer application while any other one of the devices (e.g., a different one of the mobile terminal 10 or the second and third communication devices 20 and 25) acts as a provider with respect to the consumer application to provide information such as delivery context information to the respective consumer application. The context model may be an object based model in which each provider has an object representation in the model. Thus, the context model may provide consumer applications with access to context data.

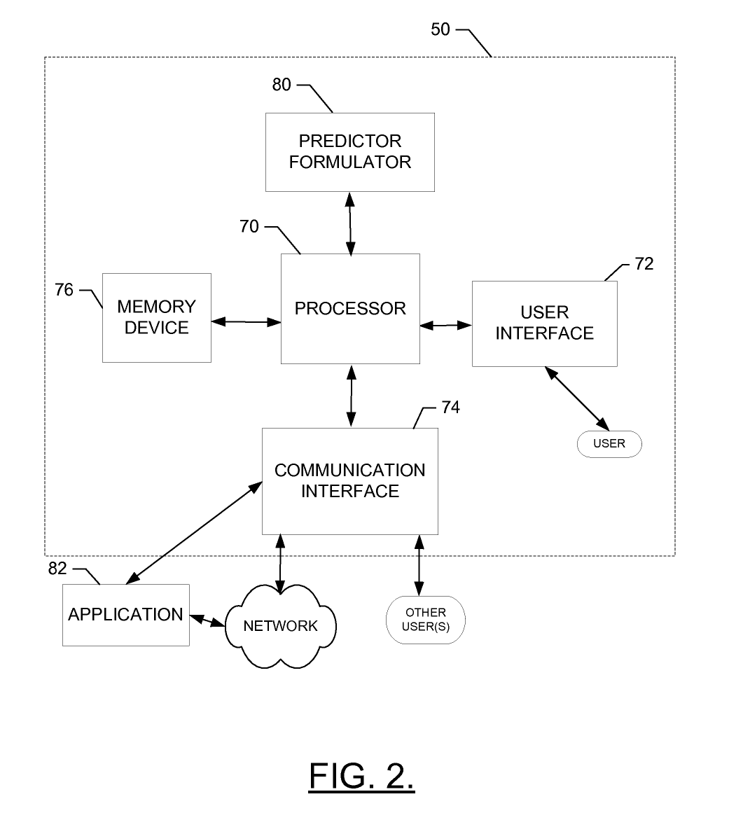

FIG. 2 illustrates a schematic block diagram of an apparatus for enabling the provision of a predictor node for a context model according to an exemplary embodiment of the present invention. An exemplary embodiment of the invention will now be described with reference to FIG. 2, in which certain elements of an apparatus 50 for providing a predictor node for a context model are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 2, an apparatus 50 for providing a predictor node for a context model is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity capable of performing operations according to embodiments of the present invention while configured accordingly.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms. In some cases, the communication interface 74 may include or be embodied as a context model (e.g., a DCCI context model).

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, remotely located, or eliminated.

In an exemplary embodiment, the processor 70 may be embodied as, include or otherwise control a predictor formulator 80. The predictor formulator 80 may be any means such as a device or circuitry embodied in hardware, software or a combination of hardware and software (e.g., processor 70 operating under software control, the processor 70 embodied as an ASIC or FPGA specifically configured to perform the operations described herein, or a combination thereof) that is configured to perform the corresponding functions of the predictor formulator 80 as described below. In this regard, for example, the predictor formulator 80 may be configured to provide for the registration of nodes and the maintenance of values over certain time intervals and the utilization of a predictor formula for certain nodes.

In some embodiments, the predictor formulator 80 may be in communication with one or more applications (e.g., application 82) that may act as consumers with respect to device context information provided (e.g., via DCCI). In other words, the applications may consume information provided by communication nodes acting as data providers. Application 82 may be a web application or some other network application for which information about properties associated with the apparatus 50 of FIG. 2 may be useful. As such, in some cases, the application 82 may be in communication with the predictor formulator 80 via the communication interface 74.

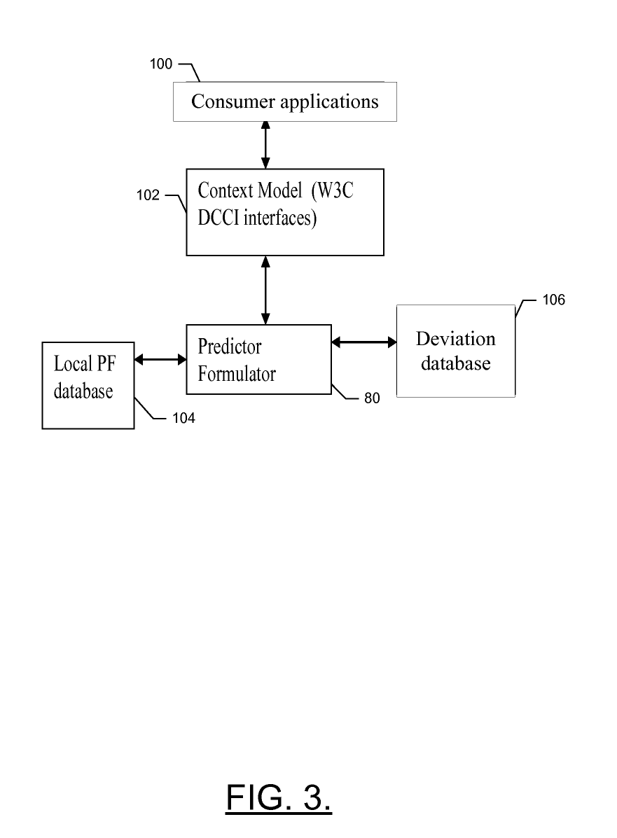

Further explanation of the operation of the predictor formulator 80 will now be provided in relation to FIG. 3, which illustrates an exemplary framework of an embodiment of the present invention for web applications. As shown in FIG. 3, consumer applications 100 (e.g., application 82) may be capable of communication with the predictor formulator 80 via the context model (e.g., W3C DCCI) 102. As such, the consumer applications 100 may access dynamic data from the context model 102. As discussed above, the context model 102 according to this example is an object based model in accordance with the W3C DCCI specification. Each provider has an object representation in the context model 102. The predictor formulator (PF) 80 is configured to keep track of values (e.g., by storing such values in a database such as the local PF database 104 and/or the deviation database 106) at certain time intervals and maintain a predictor formula for certain nodes. The values may be associated with or indicative of various properties or states of the node. As such, a value may be considered, in some cases, to be state information.

According to an exemplary embodiment, nodes register with the predictor formulator 80 to enable the predictor formulator 80 to keep track of values in association with each registered node at corresponding times. By tracking values over time, in some cases such as where the values are related to each other, the predictor formulator 80 is enabled to provide past values in response to a query for such values, or even to predict future values based on trends in the values over time.

In an exemplary embodiment, there are two types or classes of nodes, which for example purposes may be referred to as class one nodes and class two nodes. The classification of class one and class two nodes may be made based on the nature of the corresponding values associated with each respective class. In this regard, for example, class one nodes may be nodes having values that change dynamically and may be predictable (e.g., having related values). Thus, class one nodes may be candidates for having values determined or computed by the predictor formula of the predictor formulator 80. Class two nodes may be nodes having values that are generally unrelated to each other and thus, these values, rather than being predictable, may be stored at predetermined time intervals. In some instances, class two nodes, which may have unrelated values that cannot be computed by a fixed formula, may have certain adjacent values that can be related to a certain extent. For class two nodes with adjacent values that may be related, intermediate time values may be extrapolated using a pattern between the values.

When registering with the predictor formulator 80, a node (of either class) may initially declare its type or class to the predictor formulator 80. In an exemplary embodiment, class two nodes may also register a time interval with the predictor formulator 80. The registered time interval may be determined either by the owner of the respective node or the application can provide the time interval during an initialization phase of the respective node. The predictor formulator 80 may then store values that are separated by the provided/determined time interval. In some cases, an administrator may configure the predictor formulator 80 so as to set minimum and/or maximum time intervals that nodes can request from the predictor formulator 80. In such examples, the values may be stored in the local Predictor Formulator (PF) database 104 along with an identity of the respective node and a timestamp.

When registering as a class one node, a node may provide a computation formula for the predictor formulator 80 that denotes the relationships between multiple values that could be variants in time or spatial dimensions. A class one node may also provide a time interval to the predictor formulator 80. The provided time interval may be used by the predictor formulator 80 to compute values using previous values to check if any deviation has taken place. If any deviations have taken place, an “alpha” value may be stored in the deviation database 106 to indicate the deviation between a predicted value and a corresponding actual value. The alpha value may correspond to the timestamp and identifier of the corresponding object within the deviation database 106. In an exemplary embodiment, the alpha value is used to compute more accurate values when applications query for the values. If no time interval is given by a node to the predictor formulator 80, then no periodical checking may be done and the formula may always be used to compute the required value during the timeframe.

In an exemplary embodiment, the context model 102 may be extended with an additional interface for querying timebound values. For example, the interface may be expressed as:

Int getDCCINodeValue(valueStruct value);
Struct valueStruct{
Float time;
Int spatialvalue:
Typeany valueField;
String spatialMetric;
};

In this regard, the return value may indicate whether a predictor is supported for a particular node or not. The argument may be a structure that is passed by the calling application. The value struct may include a time value expressed in milliseconds (if time is the variable), spatial value along with the metric for indicating the spatial value (if space is the variable) and a valueField that may be filled by the model once the value has been computed. The computed value may be provided by the predictor formulator 80 and passed on to the respective node within the context model.

In some embodiments, where the predictor formula cannot be provided by the node itself, it may be possible for the predictor formulator 80 to query certain web services using the node name and namespace for any pre existing predictor formula. Depending on the capabilities of the predictor formulator 80, it may be possible to also derive mathematical relationships between adjacent values exposed by each node and to make corrections as a node value progresses thereby providing a learning mechanism for computing the predictor formula. Each node entry may be stored by the predictor formulator 80 with its corresponding identifier, the predictor formula, deviations, timestamp and time interval requested.

Thus, in certain scenarios, some embodiments of the present invention provide a mechanism by which a capability is provided to give past data or predictions of future data to a calling consumer application. Accordingly, provision of states of previous interactions and predictions of states in the future are possible rather than simply being able to provide current state information. Furthermore, embodiments of the present invention may also reduce dedicated storage requirements since it may not be necessary to have dedicated storage for all values within a device.

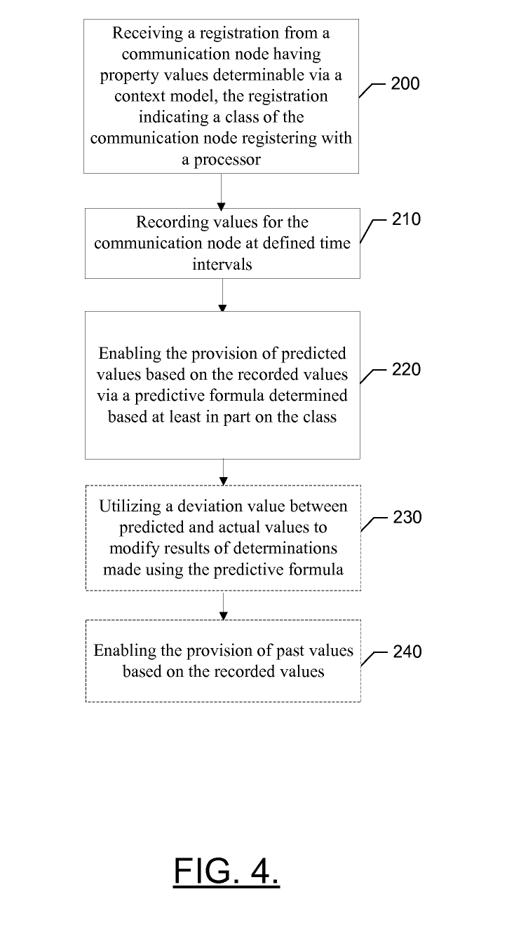

FIG. 4 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a built-in processor in the mobile terminal or network device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing predictor nodes for context models as illustrated, for example, in FIG. 4 includes receiving a registration from a communication node (e.g., a data provider node) having property values determinable via a context model in which the registration indicates a class of the communication node registering at operation 200. The method further includes recording values for the communication node at defined time intervals at operation 210 and enabling the provision of predicted values based on the recorded values via a predictive formula determined based at least in part on the class at operation 220.

In some embodiments, the method may include further optional operations, examples of which are shown in dashed lines in FIG. 4. Optional operations may be performed in any order and/or in combination with each other in various alternative embodiments. As such, the method may further include an operation of utilizing a deviation value between predicted and actual values to modify results of determinations made using the predictive formula at operation 230. Additionally or alternatively, the method may include enabling the provision of past values based on the recorded values at operation 240.

In some embodiments, certain ones of the operations above may be modified or further amplified as described below. It should be appreciated that each of the modifications or amplifications below may be included with the operations above either alone or in combination with any others among the features described herein. In this regard, for example, recording values at defined time intervals may include recording values at time intervals provided by the communication node. In some cases, enabling provision of the past or predicted values includes determining the predictive formula based on a relationship between multiple recorded values that vary in a time or spatial dimension in response to the class having related values (e.g. class one nodes). Alternatively or additionally, enabling provision of the past or predicted values may include determining the predictive formula based on a relationship between multiple recorded values that vary in a spatial dimension in response to the class having related values. In some cases, enabling provision of the past or predicted values includes utilizing adjacent values to the recorded values for a class having values that are not related (e.g., class two nodes) to extrapolate values between the recorded values in which the adjacent values are stored over intermediate time periods. In some situations, the predictive formula may be received in response to a query to a web service for a pre-existing predictive formula for the communication node. In an exemplary embodiment, enabling provision of the past or predicted values includes utilizing recorded values to compute a predicted value for comparison to another value and determining a deviation from the predicted value for application of the deviation in predicting future values.

In an exemplary embodiment, an apparatus for performing the method of FIG. 4 above may comprise a processor (e.g., the processor 70) configured to perform some or each of the operations (200-240) described above. The processor may, for example, be configured to perform the operations (200-240) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-240 may comprise, for example, the processor 70, the predictor formulator 80, and/or an algorithm executed by the processor 70 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a registration from a communication node having property values determinable via a context model, the registration indicating a class of the communication node registering with a processor;
recording values for the communication node at defined time intervals; and
enabling the provision of predicted values based on the recorded values via a predictive formula determined based at least in part on the class.

2. A method according to claim 1, wherein recording values at defined time intervals comprises recording values at time intervals provided by the communication node.

3. A method according to claim 1, wherein enabling provision of the predicted values comprises determining the predictive formula based on a relationship between multiple recorded values that vary in a time dimension in response to the class having related values.

4. A method according to claim 1, wherein enabling provision of the predicted values comprises determining the predictive formula based on a relationship between multiple recorded values that vary in a spatial dimension in response to the class having related values.

5. A method according to claim 1, wherein enabling provision of the predicted values comprises utilizing adjacent values to the recorded values for a class having values that are not related to extrapolate values between the recorded values, the adjacent values being stored over intermediate time periods.

6. A method according to claim 1, wherein enabling provision of the predicted values comprises receiving an indication of the predictive formula in response to a query to a web service for a pre-existing predictive formula for the communication node.

7. A method according to claim 1, wherein enabling provision of the predicted values comprises utilizing recorded values to compute a predicted value for comparison to another value and determining a deviation from the predicted value.

8. A method according to claim 7, further comprising utilizing the deviation to modify results of determinations made using the predictive formula.

9. A method according to claim 1, further comprising enabling the provision of past values based on the recorded values.

10. A computer program product comprising at least one computer-readable storage medium having computer-executable program code instructions stored therein, the computer-executable program code instructions comprising:
program code instructions for receiving a registration from a communication node having property values determinable via a context model, the registration indicating a class of the communication node registering;
program code instructions for recording values for the communication node at defined time intervals; and
program code instructions for enabling the provision of predicted values based on the recorded values via a predictive formula determined based at least in part on the class.

11. An apparatus comprising:
a processor
memory including computer program code
the memory and the computer program code configured to, working with the processor, cause the apparatus to perform at least the following:
receive a registration from a communication node having property values determinable via a context model, the registration indicating a class of the communication node registering;
record values for the communication node at defined time intervals; and
enable the provision of predicted values based on the recorded values via a predictive formula determined based at least in part on the class.

12. An apparatus according to claim 11, wherein the processor is further configured to record values at defined time intervals by recording values at time intervals provided by the communication node.

13. An apparatus according to claim 11, wherein the processor is further configured to enable provision of the predicted values by determining the predictive formula based on a relationship between multiple recorded values that vary in a time dimension in response to the class having related values.

14. An apparatus according to claim 11, wherein the processor is further configured to enable provision of the predicted values by determining the predictive formula based on a relationship between multiple recorded values that vary in a spatial dimension in response to the class having related values.

15. An apparatus according to claim 11, wherein the processor is further configured to enable provision of the predicted values by utilizing adjacent values to the recorded values for a class having values that are not related to extrapolate values between the recorded values, the adjacent values being stored over intermediate time periods.

16. An apparatus according to claim 11, wherein the processor is further configured to enable provision of the predicted values by receiving an indication of the predictive formula in response to a query to a web service for a pre-existing predictive formula for the communication node.

17. An apparatus according to claim 11, wherein the processor is further configured to enable provision of the predicted values by utilizing recorded values to compute a predicted value for comparison to another value and determining a deviation from the predicted value.

18. An apparatus according to claim 17, wherein the processor is further configured to utilize the deviation to modify results of determinations made using the predictive formula.

19. An apparatus according to claim 11, wherein the processor is further configured to enable the provision of past values based on the recorded values.

20. An apparatus comprising:
means for receiving a registration from a communication node having property values determinable via a context model, the registration indicating a class of the communication node registering;
means for recording values for the communication node at defined time intervals; and
means for enabling the provision of predicted values based on the recorded values via a predictive formula determined based at least in part on the class.

21. An apparatus according to claim 20, further comprising means for utilizing a deviation value between predicted and actual values to modify results of determinations made using the predictive formula.
